(19) United States
(12) Patent Application Publication
(10) Pub. No.: US 2023/0281228 A1
(43) Pub. Date: Sep. 7, 2023

(54) GENERATING ACTIONABLE INSIGHT INFORMATION FROM DATA SETS USING AN ARTIFICIAL INTELLIGENCE-BASED NATURAL LANGUAGE INTERFACE

(71) Applicant: Narrative BI, Inc., Middletown, DE (US)

(72) Inventors: Aliaksei Vertsel, Redwood City, CA (US); Mikhail Rumiantsau, San Francisco, CA (US); Yury Koleda, Minsk (BY)

(73) Assignee: Narrative BI, Inc., Middletown, DE (US)

(21) Appl. No.: 18/298,501

(22) Filed: Apr. 11, 2023

Related U.S. Application Data
(63) Continuation-in-part of application No. 17/880,331, filed on Aug. 3, 2022.
(60) Provisional application No. 63/228,719, filed on Aug. 3, 2021.

(51) Int. Cl. G06F 16/332; G06F 16/33

(52) U.S. Cl. CPC G06F 16/3323; G06F 16/3329; G06F 16/3344

(57) ABSTRACT

Systems and methods are described for automatically generating natural language queries and chatbot-assisted responses to the queries. A server may generate observed fact data structures from numeric-type data columns of a data set received from a client device over a network connection. From the generated observed facts, a subset of priority observed facts may be identified based on a plurality of priority factors associated with each observed fact. To generate actionable text recommendations, the server may combine one of the priority observed facts with a natural language template retrieved from a template database. The resulting populated natural language template may then be augmented with a selected call to action query selected based on a received user explanation type. The chatbot service may then cause a text recommendation to be transmitted to a user device that is responsive to the format and values contained within the augmented natural language template.

### CROSS-REFERENCE TO RELATED APPLICATIONS

This application is a continuation-in-part of U.S. application Ser. No. 17/880,331, filed Aug. 3, 2022, which claims the benefit of U.S. Provisional Patent Application No. 63/228,719, filed Aug. 3, 2021, the entire contents of both are incorporated herein by reference,

### TECHNICAL FIELD

This disclosure relates generally to the technical field of computer-implemented methods for linking data sets with visualizations. Specifically, the disclosure describes automatically generating natural language queries and chatbot-assisted responses to the queries on various interfaces in response to an analysis of the data set.

### SUMMARY OF THE INVENTION

Systems and methods are described for automatically generating natural language queries and chatbot-assisted responses to the queries. A server may generate Observed facts from numeric-type data columns of the data set received from a client device over a network connection. Each observed fact may be a data structure that includes an amount of change of a corresponding numeric-type data column over a predetermined period of time. From the generated observed facts, a subset of priority observed facts may be identified based on a plurality of priority factors associated with each observed fact. Each priority factor being a value assigned to the observed fact, and may be derived from data within the observed fact, or may be separately assigned, for example, based upon the column of the data set associated with the observed fact.

To generate actionable text recommendations, the server may combine one of the priority observed facts with a natural language template retrieved from a template database. The natural language template may be a textual statement with placeholder strings, where one or more of the placeholder strings is replaced with values from the one of the priority observed facts to generate a populated natural language template. This populated natural language template may then be augmented with a selected call to action query, the call to action query being selected based on a received user explanation type, to improve interactivity with the chatbot. The augmented natural language template may then be transmitted to a display device, and also to the web-based chatbot service. The chatbot service may then cause a text recommendation to be transmitted to a user device, the text recommendation providing information responsive to the format and values contained within the augmented natural language template.

### BRIEF DESCRIPTION OF THE FIGURES

This disclosure is illustrated by way of example and not limitation in the figures of the accompanying drawings, in which like references indicate similar elements, and in which:

FIG. 1 is a block diagram illustrating an example operating environment for deriving and applying insight templates to received data sets, according to one or more embodiments of the disclosure.

FIG. 2 is a flow diagram illustrating an example method of generating and displaying an insight graphic interface according to one or more embodiments of the disclosure.

FIG. 3 is a block diagram of a virtual company model linking data sources and performance indicators according to one or more embodiments of the disclosure.

FIG. 4 is a block diagram illustrating data mapping using data sets formatted using preexisting data templates according to one or more embodiments of the disclosure.

FIG. 5 is a block diagram illustrating an exemplary insight data structure according to one or more embodiments of the disclosure.

FIGS. 6A-D show exemplary insight templates according to one or more embodiments of the disclosure.

FIG. 7 is a screenshot illustrating configurable settings for a insight template according to one or more embodiments of the disclosure.

FIG. 8 is a flow diagram illustrating an example method of utilizing user feedback for insight templates according to one or more embodiments of the disclosure.

FIG. 9 is a screenshot illustrating an insight graphic interface according to one or more embodiments of the disclosure.

FIG. 10 is a block diagram illustrating an example computing system that may be used in conjunction with one or more embodiments of the disclosure.

FIG. 11 is a block diagram illustrating an example operating environment for automatically generating natural language queries and chatbot-assisted responses to the queries, according to one or more embodiments of the disclosure.

FIG. 12 is a flow diagram illustrating an example method of automatically generating natural language queries and chatbot-assisted responses to the queries according to one or more embodiments of the disclosure.

FIG. 13 is a flow diagram illustrating an example data flow for generating natural language narratives from a received data set and data configuration for the data set, according to one or more embodiments of the disclosure.

FIG. 14 is a flow diagram illustrating an example method of automatically generating a data configuration for a received data set, according to one or more embodiments of the disclosure.

FIGS. 15A-B show exemplary interfaces showing natural language augmented natural language templates and a corresponding text recommendation generated by an AI chatbot service, respectively, according to one or more embodiments of the disclosure.

### DETAILED DESCRIPTION

Legacy business intelligence (“BI”) systems and dashboards are descriptive: they require further interpretation by a data-savvy professional. Actionable insights described herein may track past decisions, plan actions, and mark events on the timeline for adoption (by providing relevant insights and/or actionable recommendations). Businesses may have several very similar parts (e.g. marketing, sales, salaries, taxes, expenses) and as a result very similar key performance indicators (KPIs) for these metrics. A high-level virtual model of a business may allow business users to see as many KPIs as possible depending on the amount of input data and mapping of input data to virtual model inputs. As a result, generated insights may be based on real business KPIs and can be converted to recommendations presented on a graphic user interface.

Methods and systems for users to generate actionable recommendations for insight using internal virtual company model (VCM) and actionable templates for specific company states for specific or general verticals are described herein. The data set may be tagged, and then mapped to a set of performance indicator expressions. Key performance indicators (KPIs) may be determined based on the mapped data set. Using the mapped data set, a virtual company model may then be generated, where the virtual company model is a graph with data sources (variables) acting as root nodes and performance indicators on leaf nodes. Once the system calculates all available KPIs—all the results together are stored as a company performance snapshot. These snapshots are used to match actionable recommendation templates against them.

Subsequently, a database of actionable insight templates may be accessed, where each template contains multiple rules which apply restrictions on the current company performance snapshot. Specific templates may be selected from the database based on the specific templates matching data in the performance snapshot by a matching module. The specific templates may then be applied to the mapped data set to automatically generate one or more actionable insight interfaces. The actionable insight interfaces may be displayed on a display of a computer system, where each actionable insight interface includes one or more recommendations derived from the application of the specific templates to the mapped data set.

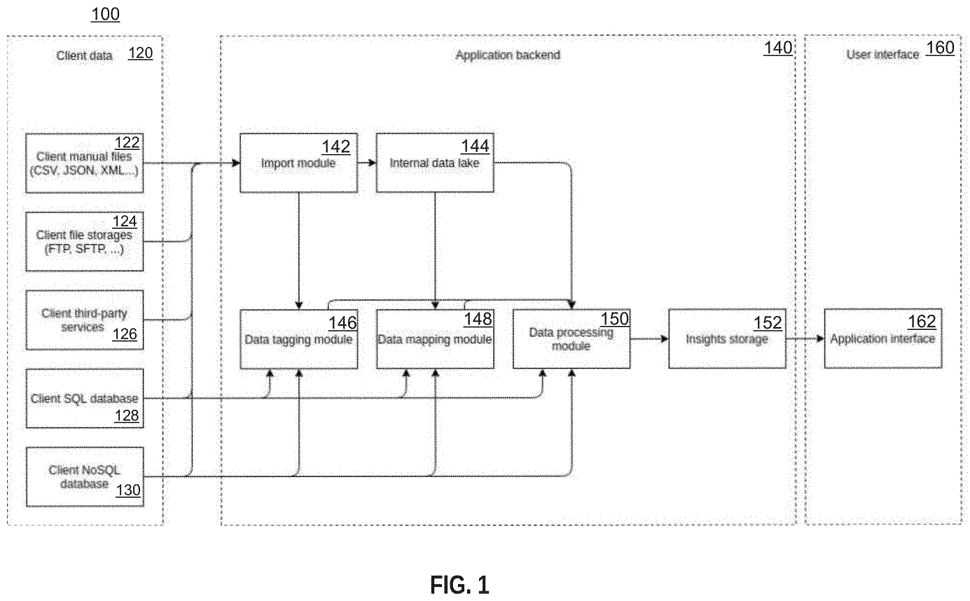

More specifically, and with reference to FIG. 1, shown is a block diagram illustrating an example of an operating environment 100 for deriving and applying insight templates to received data sets, according to one or more embodiments of the disclosure. As shown, the operating environment 100 may include a client system 120, an application back end 140, and a user interface 160. It should be noted that the components of operating environment 100 may interact via network connections, which may be any type of wired or wireless network including a local area network (LAN), a wide area network (WAN), or a direct communication link, or other suitable connection.

The communications network used by elements 120, 140, and 160 to communicate may itself be comprised of many interconnected computer systems and communication links. The communications links may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, the communication network is the Internet, in other embodiments, the communication network may be any suitable communication network including a local area network (LAN), a wide area network (WAN), a wireless network, a intranet, a private network, a public network, a switched network, and combinations of these, and the like.

Client data systems 120 may include client manual files 122, client file storages 124, third party data storage services 126, SQL databases 128, and/or non-SQL databases 130. The application backend 140 may include import module 142 to retrieve data from the client data sources 120. The import module 142 may be communicatively coupled to internal data lake 144 and data tagging module 146, whose operation is described in greater detail below. The tagging module 146 and data lake 144 may operate together with data mapping module 148 and data processing module 150 to generate a tagged and mapped version of a data set received from one or more of the client data sources 120. The output tagged and mapped data set may be then matched to various insight templates stored in insights storage 152 to generate an insight graphical interface, which may be transmit to the application interface 162 of the user interface 160.

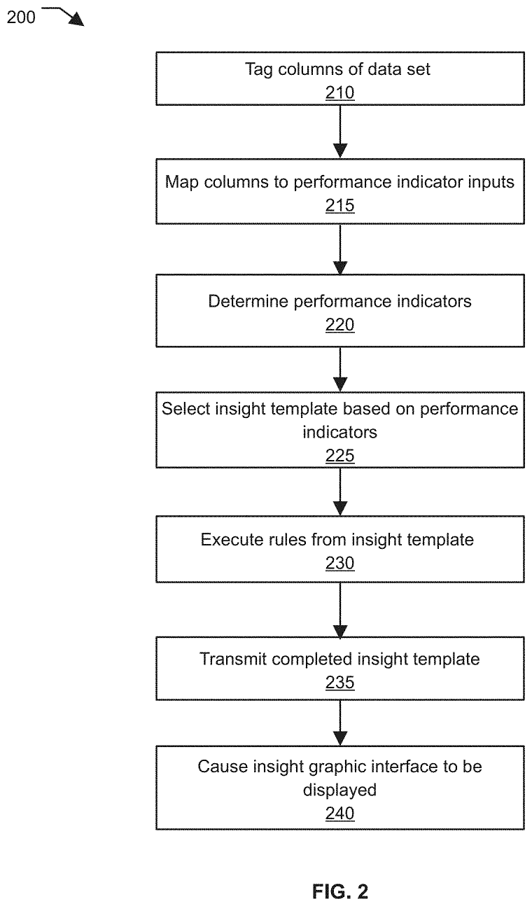

FIG. 2 is a flow diagram illustrating an example method 200 of generating and displaying an insight graphic interface according to one or more embodiments of the disclosure. Process 200 may use processing logic, which may include software, hardware, or a combination thereof. For example, process 200 may be performed by a system including one or more components described in operating environment 100.

In block 210, a server (e.g. application backend 140) may tag data columns of a data set, which is received from a client device (e.g. one of client data sources 120) over a network connection. The data tagging system allows each data column to be associated with specific data types and dimensional/categorical data. The dimensional/categorical data may be used for data interpretation by various internal algorithms. Examples of data columns with their data types and dimensions are listed below:

```
{
  ″datatype[CLIENT_NAME/tasks/_id]″: ″id″,
  ″property[CLIENT_NAME/tasks/_id]″: ″dimension″,
  ″datatype[CLIENT_NAME/courses/_id]″: ″id″,
  ″property[CLIENT_NAME/courses/_id]″: ″dimension″,
  ″datatype[CLIENT_NAME/payments/price]″: ″numerical″,
  ″datatype[CLIENT_NAME/tasks/title.en]″: ″categorical″,
  ″datatype[CLIENT_NAME/tasks/title.ru]″: ″categorical″,
  ″property[CLIENT_NAME/payments/price]″: ″metric″,
  ″property[CLIENT_NAME/tasks/title.en]″: ″dimension″,
  ″property[CLIENT_NAME/tasks/title.ru]″: ″dimension″,
  ″datatype[CLIENT_NAME/courses/name.en ]″: ″categorical″,
  ″datatype[CLIENT_NAME/courses/name.ru]″: ″categorical″,
  ″datatype[CLIENT_NAME/payments/userID]″: ″id″,
  ″property[CLIENT_NAME/courses/name.en]″: ″dimension″,
  ″property[CLIENT_NAME/courses/name.ru]″: ″dimension″,
  ″property[CLIENT_NAME/payments/userID]″: ″dimension″,
  ″datatype[CLIENT_NAME/payments/created]″: ″datetime″,
  ″property[CLIENT_NAME/payments/created]″: ″dimension″
}
```

The tagged data columns may be then mapped to a plurality of performance indicator inputs at block 215. The data mapping system may map any kind of client's data to the corresponding system inputs (variables) and lets the system calculate KPIs based on such variables. Each variable can be represented by several data columns. In that case, the system decides which data column should be used for specific KPI calculations depending on other variables involved in the calculation. An example of the commands that may be used to implement the mapping:

```
{
  ″columns[USER_ID]″: [ ″CLIENT_NAME/payments/userID″],
  ″columns[ORDER_DATE]″: [ ″CLIENT_NAME/payments/created″],
  ″columns[ORDER_VALUE]″: [ ″CLIENT_NAME/payments/price″]
}
```

In case a variable is represented by multiple columns, the system may perform the calculation in several steps:
Compose a full set of columns which represent all required variables for KPI calculation.
Select a subset of columns which represent all required variables and can be used for calculation. The system may search for the first available condition:
Select a subset of columns which belong to the same table;
Select a subset of columns which belong to joinable tables (we know that from the source data structure):
Select a subset of columns which belong to the same source and can be correlated by timeframe (we know that from the source data structure);
Select a subset of columns which can be correlated by timeframe (we know that from the multiple sources data structures);
Skip calculation if none available.
Run the calculation against available subset of columns.

The system may need to perform some additional processing of the tagged data.

depending on the identified data types: (1) format conversion and (2) value normalization. (1) Format conversion is needed in most cases since data sources may use various formats, e.g. it's most obvious for date and time presentation, which can be presented as YYYY-MM-DD, Year Year/Day/Month; etc. Another example is boolean data type which can be presented in a data set as “true/false”, “yes/no”, “1/0” “+/−” etc. (2) Another step of data. type processing is value normalization. An example of such processing could be normalization of categorical data types, e.g. a product category can be presented as “clothes”, “apparel”, “garment” and a specific synonym map will be needed if a certain KPI mapping formula (e.g. total sales by category) requires the system to group all objects of such category in one bucket.

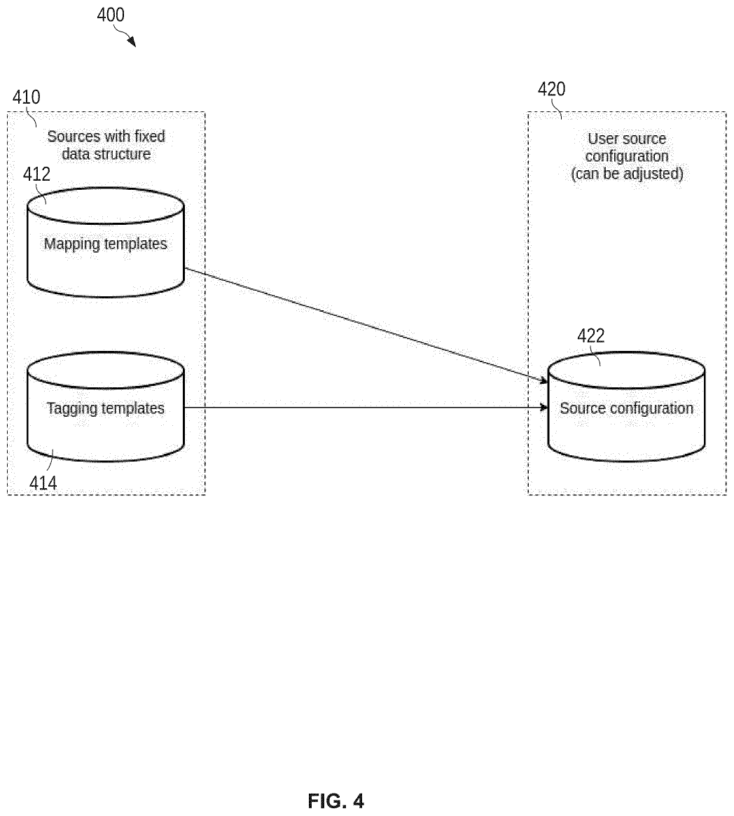

In some embodiments, predetermined mapping and tagging templates may be used for client data sources with fixed (or at least partially fixed) data structures (e.g. Google® Analytics, developed by Google Inc. of Mountain View, Calif.). This is shown in FIG. 4, a block diagram 400 illustrating data mapping using data sets formatted using preexisting data templates according to one or more embodiments of the disclosure. In case a client adds a data source 410 which has appropriate mapping templates 412 and tagging configuration templates 414, these templates will be copied directly to the user's source configuration 420. These templates provide basic and general configuration. Any specific user's data source configuration 422 can be changed anytime to meet the user's needs.

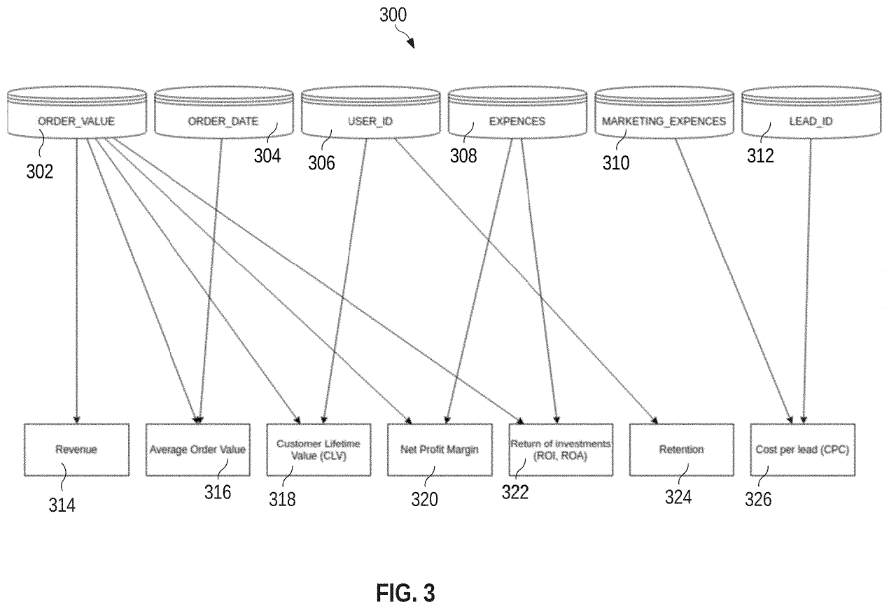

After the mapping has taken place, a plurality of performance indicators may be determined from the performance indicator inputs at block 220. In an embodiment, using the mapped data set, a virtual company model may then be generated, where the virtual company model is a graph with data sources (variables) acting as root modes and performance indicators on leaf nodes, FIG. 3 is a block diagram of a virtual company model 300 linking data sources and performance indicators according to one or more embodiments of the disclosure. As seen in model 300, the data sources 302, 304, 306, 308, 310, and 312 are root nodes linked to associated performance indicators 314, 316, 318, 320, 322, 324, and 326 Once the system calculates available KPIs—all the results together are stored as a company performance snapshot. These snapshots are used to match actionable recommendation templates against them. Incoming connections for a node mean the specific KPI might be calculated only if all the incoming connections are fulfilled (system has required data for all root elements).

KPIs are used to calculate a company's performance by different metrics. The described system uses general formulas to calculate KPIs (similar to pseudo code), and substitutes formula parameters depending on various factors (user request, current time frame, amount of data, etc.). Once the system calculates all available KPIs—all the results together are stored as a company performance snapshot. These snapshots are used to match actionable recommendation templates against them. Table 1 below displays various performance indicators and exemplary code that may be used to determine the performance indicators.

TABLE 1
List of exemplary KPI determination formula

| KPI (Metric) | Pseudo code |
|---|---|
| Average Order Value | avg(ORDER_VALUE) per ORDER_DATE |
| Bounce rate | BOUNCE_RATE per BOUNCE_DATE |
| Customer Lifetime Value (CLV) | avg(ORDER_VALUE) per USER_ID |
| Net Profit Margin | sum(ORDER_VALUE) − sum(EXPENCES) |
| Return of investments (ROI, ROA) | (sum(ORDER_VALUE) − sum(EXPENCES))/sum(EXPENCES) |
| Retention | count(DISTINCT USER_ID period N) − count(USER_ID in |
| | LIST_USER_ID period N − 1)/count(DISTINCT USER_ID perion |
| | N − 1) |
| Revenue | sum(ORDER_VALUE) |
| Cost per lead (CPC) | sum(MARKETING_EXPENCES)/count(DISTINCT LEAD_ID) |
| Conversion rate (funnel) | sum(LEVEL = N)/sum(LEVEL = N + 1) |
| Average Sales Cycle Length | count(UNIQUE ORDER_DATE)/sum(BOOL Flag deal) |
| Click through rate (CTR) | CTR per CTR_DATE |
| Cost of Customer Acquisition (CAC) | sum(EXPENCES)/count(DISTINCT USER_ID) |
| Lead Response Time | sum(LEAD_ANSWER_DATE-LEAD_START_DATE)/ |
| | count(DISTINCT LEAD_ID) |
| Response rate | avg(BOOL Flag answered calls) |
| Revenue per customer | sum(ORDER_VALUE)/count(DISTINCT USER_ID) |
| Revenue per FTE | sum(ORDER_VALUE)/count(DISTINCT EMPLOYEE_ID) |
| Customer Retur Rate | avg(BOOL Flag rejected goods) |
| Acid-Test Ratio | (sum(CASH) + sum(MARKETABLE_SECURITIES) + |
| | sum(ACCOUNTS_RECEIVABLE))/sum(LIABILITIES) |
| Avoided Cost | sum(ASSUMED_REPAIR_COST) + |
| | sum(PRODUCTION_LOSSES) − sum(PREVENTION_COST) |
| Capacity Utilization | sum(PRODUCED_GOODS)/sum(MAX_PRODUCTION_PLAN) |
| Customer Satisfaction Score (CSAT) | avg(BOOL Flag customer_mark IN [4, 5]) per USER_ID |
| Debt To Equity Ratio | sum(LIABILITIES)/sum(EQUITY) |
| Dormancy Rate | avg(BOOL Flag LAST_VISIT_DATE is not NULL) per USER_ID |
| Employee Absence Rate | avg(BOOL Flag STATUS = ABSENT) per EMPLOYEE_ID |
| Employee Turnover Rate | avg(BOOL Flag STATUS = LEFT) per EMPLOYEE_ID |
| First Pass Yield (FPY) | avg(BOOL QUALITY_CONTROLL) |
| First Response Time (FRT) | sum(MIN(TICKET_ANSWER_DATE)-TICKET_START_DATE)/ |
| | count(DISTINCT TICKET_ID) |
| Free Cash Flow (FCF) | sum(EBIT) + sum (DEPRECIATION) + sum(TAXES) − |
| | (sum(WORKING CAPITAL period N + 1) − sum(WORKING |
| | CAPITAL period N)) − sum(CAPITAL_EXPEDITURES) |
| Levered Cash Flow (LCF) | sum(EBITDA) + sum (DEPRECIATION) − (sum(WORKING |
| | CAPITAL period N + 1) − sum(WORKING CAPITAL period N)) − |
| | sum(CAPITAL_EXPEDITURES) − sum(DEBT_PAYMENTS) |
| Net Present Value (NPV) | sum(CASH_EXPECTED)/sum(CASH_INVESTED) |
| Net Promoter Score (NPS) | (count(QUESTION_WILL_YOU_ADVICE_APP_FREIEND = YES) − |
| | count(QUESTION_WILL_YOU_ADVICE_APP_FREIEND = NO)) / |
| | count(QUESTION_WILL_YOU_ADVICE_APP_FREIEND IS NOT |
| | NULL) |
| On-Time Delivery | avg(BOOL Flag IS_DELAYED) |
| Operating Cash Flow | sum(EBIT) + sum (DEPRECIATION) + sum(TAXES) − |
| | (sum(WORKING CAPITAL period N + 1) − sum(WORKING |
| | CAPITAL period N)) |
| Payroll Headcount Ratio | avg(BOOL Flag POSITION_TYPE = FULL_TIME) per |
| | EMPLOYEE_ID |
| Return on assets | (sum(ORDER_VALUE) − sum(NET_COST))/sum(ASSETS) |
| Return on Equity (ROE) | (sum(ORDER_VALUE) − sum(EXPENCES))/ |
| | sum(STACKEHOLDERS EQUITY) |
| Working Capital Ratio | sum(ASSETS)/sum(LIABILITIES) |

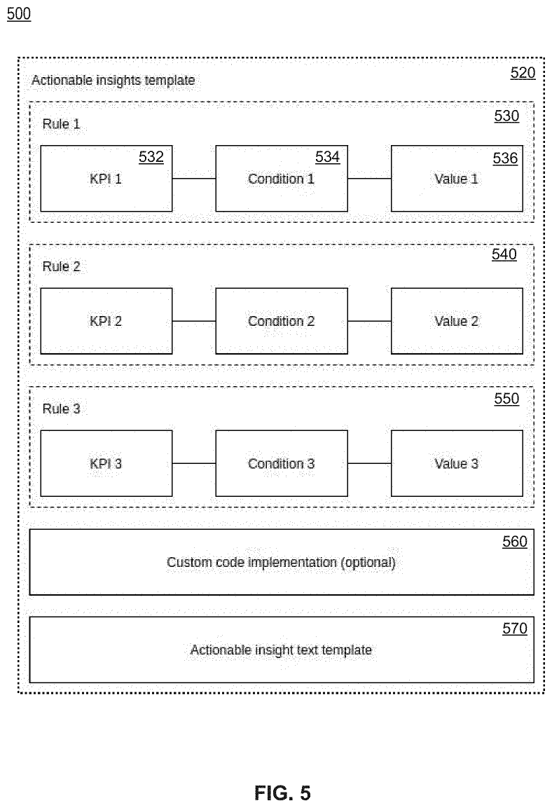

A selected insight template may then be retrieved, by the server, from a plurality, of insight templates stored within a template database at block 225. The retrieved insight template may be selected based on the determined performance indicators matching input requirements of the selected insight template. FIG. 5 is a block diagram 500 illustrating an exemplary insight data structure according to one or more embodiments of the disclosure. Each insight template 520 stored within the template database may be stored as a data object that includes a plurality of rules 530, 540, and 550. Each template may include multiple rules which apply restrictions on the current company performance snapshot. Rules may be defined as simple restrictions (logical operators with fixed values).

Each rule may receive one or more performance indicators 532 as inputs and derive a rule output 536 from the received performance indicators using a condition 534. The data object of each insight template may also include narrative text 570 that provides a text recommendation based on the rule outputs (such as rule output value 536). Actionable insight text templates 570 may contain text which supports variable interpolation. Variables may be calculated by the custom code 560 or be taken directly from the company performance snapshot (e.g., using specific KPIs). In some embodiments, a custom code implementation 560 may be included, for example, to derive one or more visualizations based on the rule outputs from rules 530, 540, and 550. Custom code 560 may also be used for complex calculations (e.g. specific values in actionable insight text or custom complex rules). Some exemplary insight templates might contain no rules, and may only evaluate custom code to generate actionable insights.

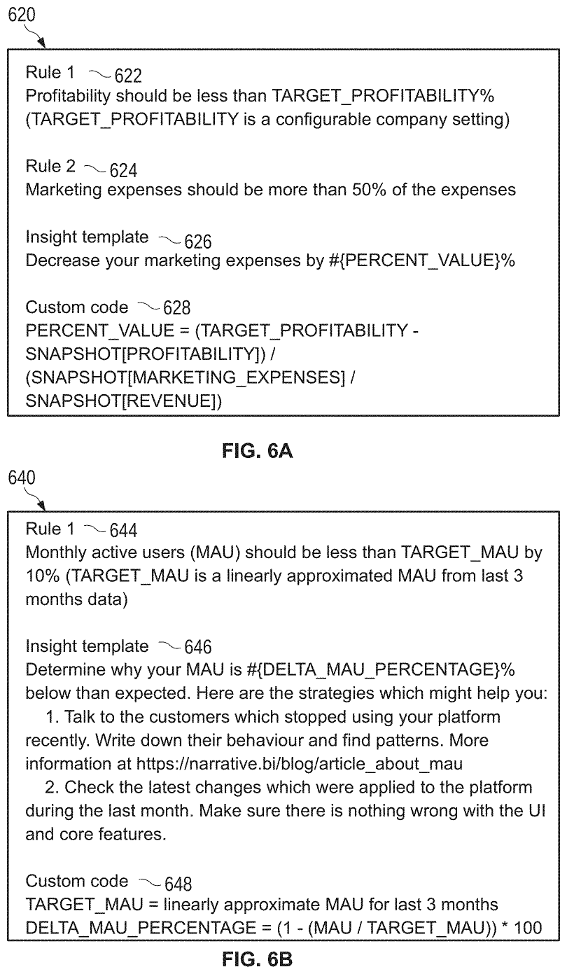

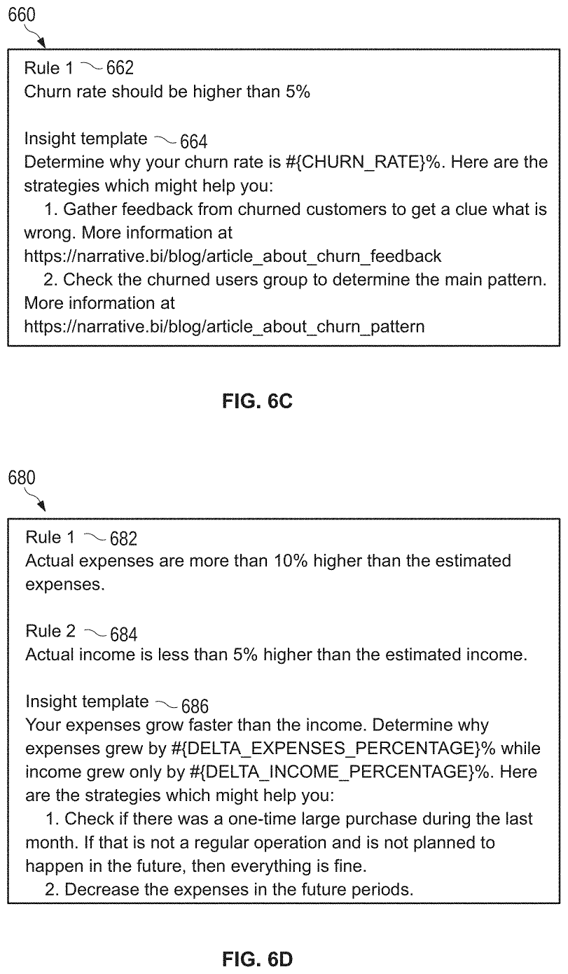

FIGS. 6A-D show exemplary insight templates 620, 640, 660, and 680 according to one or more embodiments of the disclosure. Each template, which may be stored within a template database, includes one or more rules 622, 624, 644, 662, 682, and 684, and narrative text in the form of insight templates 626, 646, 664, and 686. Some of the insight templates shown include custom code 628 and 648, used for more complex determinations.

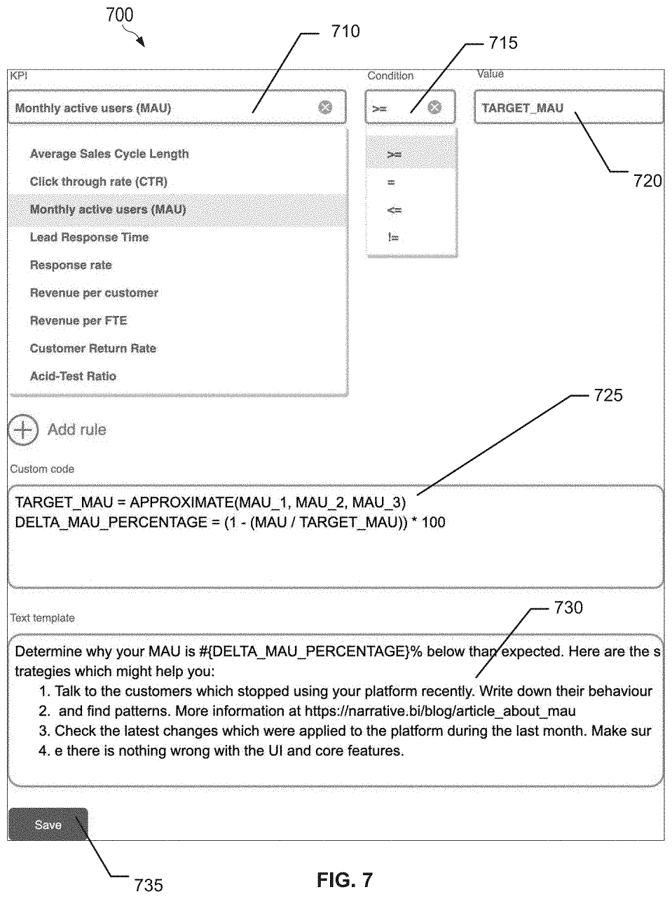

When a new client data source is added, the information about the source and data structure inside that source may be used to create a list of KPIs (metrics) which can be calculated using the data from the new source. After that, a user may compose another list of actionable insights which can be created using available KPIs and data. These specific insights may be added to an actionable insights template database by, for example, using an insight template form. FIG. 7 is a screenshot 700 illustrating configurable settings for an insight template according to one or more embodiments of the disclosure. As shown in screenshot 700, the insight template intake form may include selectable options for performance indicators 710, the condition for a rule 715, and the rule output name 720. Input areas for custom code 725 and narrative text 730 may also be included. Once a user has finished inputting at least one rule and the narrative text for the new insight template, the insight template may be saved to the template database by the user selecting save button 735.

In an exemplary embodiment, the system may select only applicable actionable insight templates by vertical and time frame. Some insights might not have a specific vertical; in that case they are matched to any vertical. As a second step, the system matches all applicable actionable insight templates against the current company performance snapshot. If all template conditions are satisfied, the recommendation will be generated and added to the insight automatically.

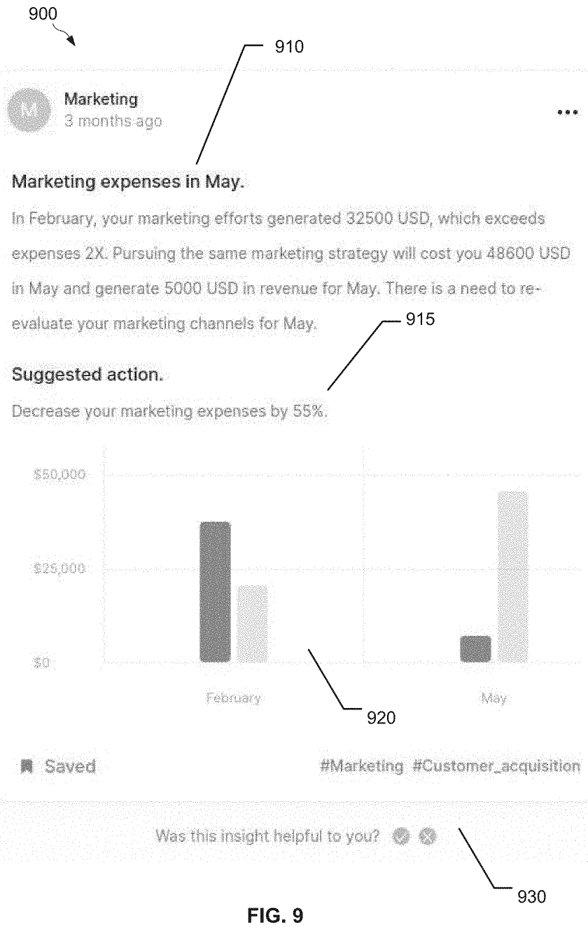

Returning to method 200, the server may then execute the rules included within the selected insight template at block 230 using the determined plurality of performance indicators for the received data set. After the rules have been executed, the server may transmit, via the network connection, the narrative text and the rule outputs to a display device (such as user interface 160) at block 235. The server may then cause an insight graphic interface to be displayed by the display device, where the insight graphic interface includes the text recommendation, at block 240. FIG. 9 is a screenshot 900 illustrating an insight graphic interface according to one or more embodiments of the disclosure. The exemplary insight graphic interface may include the narrative text 910 complete with any values included in the narrative text. A recommendation 915 is also included as part of the narrative text recommending what actions the user can take to improve the performance indicators. Exemplary insight graphic interface 900 also includes visualization 920 derived from the performance indicators. Finally, feedback features 930 allow a user to provide feedback, which may be used as input to method 800, for example.

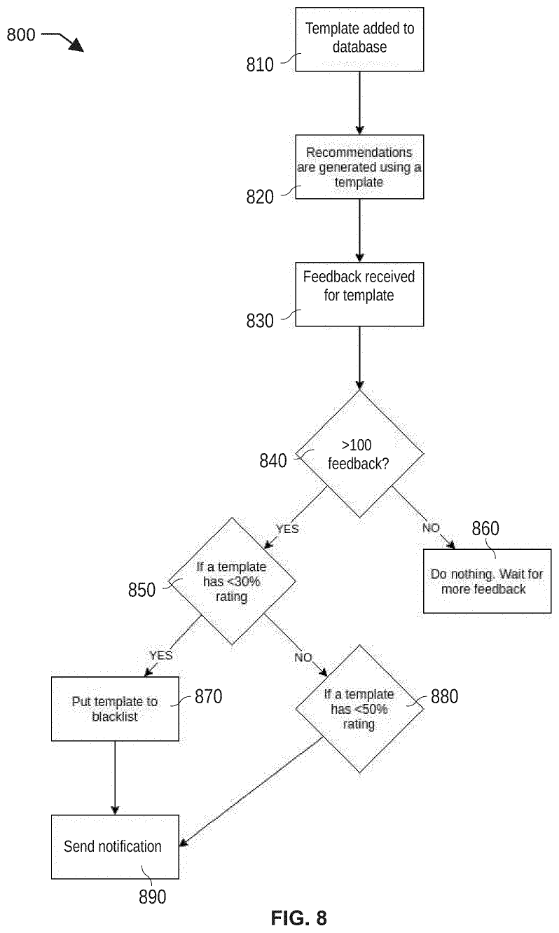

Some embodiments of the present invention may also allow the user the system to configure which types of actionable insights should be displayed or hidden in the output of the system. Depending on the specific business setup, certain KPIs might appear to be more or less important in the decision making process, therefore allowing the user to mark those KPIs as important or not important may provide additional value and make the system more usable. FIG. 8 is a flow diagram illustrating an example method of utilizing user feedback for insight templates according to one or more embodiments of the disclosure. After a insight template is added to the database at block 810, a recommendation template may be generated for the insight template at block 820. The template may allow users to provide feedback on the quality and business value of the generated insights, e.g. by adding “like” and “dislike” buttons in the user interface associated with the recommendation template. At block 840, the amount of feedback may be tallied for the insight template and compared to a threshold (e.g. 100 in the exemplary embodiment). When there is fewer than the threshold amount of feedback received, no action is taken at block 860. When the threshold is met, the method 800 proceeds to block 850, where a determination is made if the insight template has less than a second threshold amount of positive reviews. If the number of positive feedback reviews is less than the second threshold, the insight template may be added to a blacklist at block 870 and removed from the template database until further action by an administrator. At block 880, when the insight template has more than the minimum second threshold of positive feedback, another determination is made, to see if the insight template has greater than a third threshold of positive feedback. When the template has more than the third threshold of positive feedback (e.g., 50%), a notification may be automatically generated and transmitted to an administrator to flag the insight template as particularly useful. Such feedback information collected from the user, may be used by the system to decide whether to display or hide such insights from the user in the future.

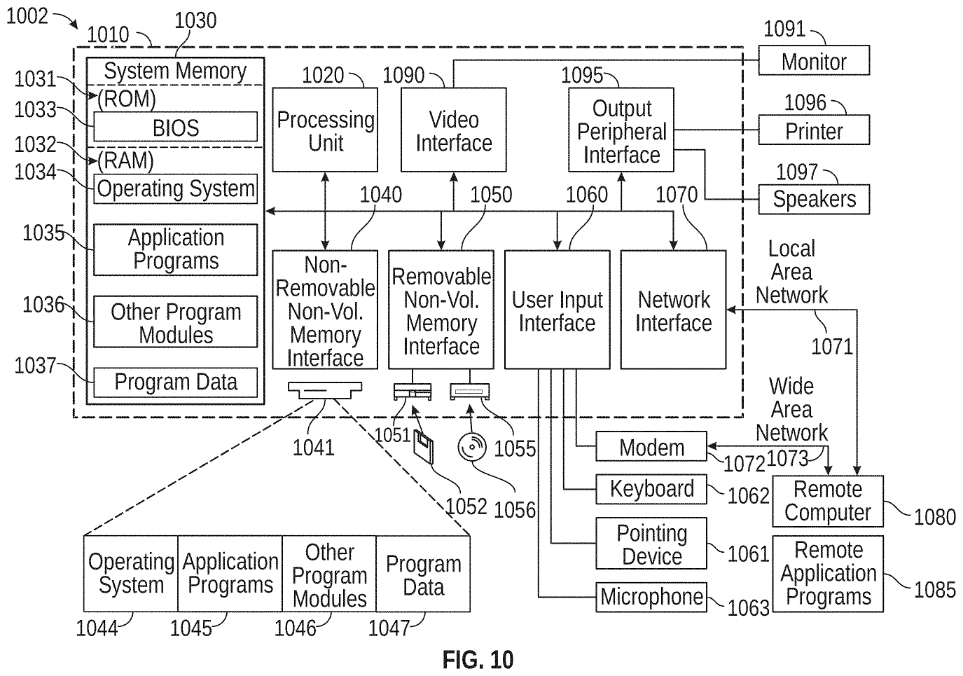

FIG. 10 is a diagram of an example computing system that may be used with some embodiments of the present invention. The computing system 1002 is only one example of a suitable computing system, such as a mobile computing system, and is not intended to suggest any limitation as to the scope of use or functionality of the design. Neither should the computing system 1002 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 1002 may be implemented as a mobile computing system such as one that is configured to run with an operating system (e.g., iOS) developed by Apple Inc. of Cupertino, Calif. or an operating system (e.g., Android) that is developed by Google Inc. of Mountain View, Calif.

Some embodiments of the present invention may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine readable media discussed below.

Some embodiments of the present invention may also be practiced in distributed computing environments where tasks are performed by remote processing devices that are linked through a communications network. In a distributed computing environment, program modules may be located in both local and remote computer storage media including memory storage devices.

Referring to FIG. 10, the computing system 1002 may include, but are not limited to, a processing unit 1020 having one or more processing cores, a system memory 1030, and a system bus 1021 that couples various system components including the system memory 1030 to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 1002 typically includes a variety of computer readable media. Computer readable media can be any available media that can be accessed by computing system 1002 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 1002. Communication media typically embodies computer readable instructions, data structures, or program modules.

The system memory 1030 may include computer storage media in the form of volatile and/or nonvolatile memory such as read only memory (ROM) 1031 and random access memory (RAM) 1032. A basic input/output system (BIOS) 1033, containing the basic routines that help to transfer information between elements within computing system 1002, such as during start-up, is typically stored in ROM 1031. RAM 1032 typically contains data and/or program modules that are immediately accessible to and/or presently being operated on by processing unit 1020. By way of example, and not limitation, FIG. 10 also illustrates operating system 1034, application programs 1035, other program modules 1036, and program data 1037.

The computing system 1002 may also include other removable/non-removable volatile/nonvolatile computer storage media. By way of example only, FIG. 10 also illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 10, provide storage of computer readable instructions, data structures, program modules and other data for the computing system 1002. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. The operating system 1044, the application programs 1045, the other program modules 1046, and the program data 1047 are given different numeric identification here to illustrate that, at a minimum, they are different copies.

A user may enter commands and information into the computing system 1002 through input devices such as a keyboard 1062, a microphone 1063, and a pointing device 1061, such as a mouse, trackball or touch pad or touch screen. Other input devices (not shown) may include a joystick, game pad, scanner, or the like. These and other input devices are often connected to the processing unit 1020 through a user input interface 1060 that is coupled with the system bus 1021, but may be connected by other interface and bus structures, such as a parallel port, game port or a universal serial bus (USB). A monitor 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1090.

The computing system 1002 may operate in a networked environment using logical connections to one or more remote computers, such as a remote computer 1080. The remote computer 1080 may be a personal computer, a hand-held device, a server, a router, a network PC, a peer device or other common network node, and typically includes many or all of the elements described above relative to the computing system 1002. The logical connections depicted in FIG. 5 include a local area network (LAN) 1071 and a wide area network (WAN) 1073, but may also include other networks. Such networking environments are commonplace in offices, enterprise-wide computer networks, intranets and the Internet.

When used in a LAN networking environment, the computing system 1002 may be connected to the LAN 1071 through a network interface or adapter 1070. When used in a WAN networking environment, the computing system 1002 typically includes a modem 1072 or other means for establishing communications over the WAN 1073, such as the Internet. The modem 1072, which may he internal or external, may be connected to the system bus 1021 via the user-input interface 1060, or other appropriate mechanism. In a networked environment, program modules depicted relative to the computing system 1002, or portions thereof, may be stored in a remote memory storage device. By way of example, and not limitation, FIG. 5 illustrates remote application programs 1085 as residing on remote computer 1080. It will be appreciated that the network connections shown are exemplary and other means of establishing a communications link between the computers may be used.

It should be noted that some embodiments of the present invention may be carried out on a computing system such as that described with respect to FIG. 5. However, some embodiments of the present invention may be carried out on a server, a computer devoted to message handling, handheld devices, or on a distributed system in which different portions of the present design may be carried out on different parts of the distributed computing system.

Another device that may be coupled with the system bus 1021 is a power supply such as a battery or a Direct Current (DC) power supply) and Alternating Current (AC) adapter circuit. The DC power supply may be a battery, a fuel cell, or similar DC power source needs to be recharged on a periodic basis. The communication module (or modem) 1072 may employ a Wireless Application Protocol (WAP) to establish a wireless communication channel. The communication module 1072 may implement a wireless networking standard such as Institute of Electrical and Electronics Engineers (IEEE) 802.11 standard, IEEE std. 802.11-1999, published by IEEE in 1999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

Using data in the decision making process is becoming more and more critical in the current economy. With a data-driven decision making approach, the more data in general that is collected and stored, the more precise and reliable results may be provided. However, this growing stream of data creates a problem commonly known as data overload, where the sheer volume of data becomes very hard to manage, process and analyze. Tools and methods which allow to automate data processing and extraction of valuable pieces of actionable information from a large quantity of raw data would rapidly become a vital part of a modern organization.

One kind of powerful tool increasing in popularity is a general purpose “artificial intelligence” (AI) chatbot with a natural language interface to receive user queries. Such AI chatbots, which are often provided as cloud-based web services accessible via web browser or desktop/mobile application, may be based on neural networks trained against massive corpora of natural language texts and combine (1) the versatility of search engines, as their capabilities cover basically any knowledge domain described in the texts of the training set, and (2) the power of expression and flexibility of a natural language interface.

The methods and systems described below can serve as an improved bridge between a large business-derived data set and the flexibility and versatility of AI chatbots by first generating natural language text based on business data facts that are determined to be important, and then providing the natural language text to the chatbot for a refined text recommendation. Getting meaningful explanations and recommendations related to that text from an AI chatbot (or several chatbots) and displaying those responses to the user may advantageously support the decision-making process by providing a recommendation responsive to the format and values included in the natural language text input.

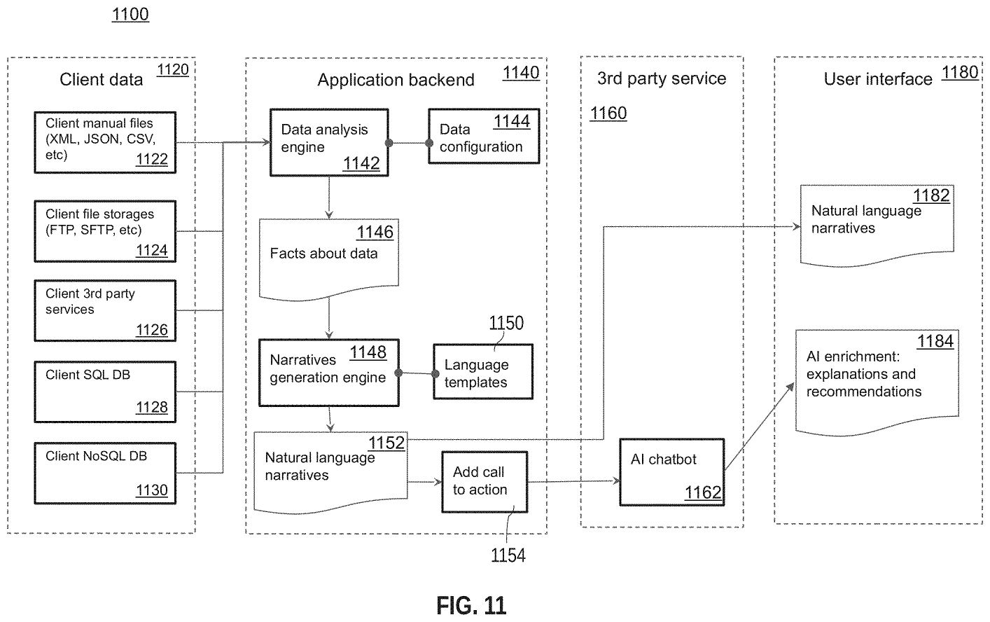

More specifically, and with reference to FIG. 11, shown is a block diagram illustrating an example of an operating environment 1100 for automatically generating natural language queries and chatbot-assisted responses to the queries, according to one or more embodiments of the disclosure. As shown, the operating environment 100 may include a client system that includes 1120, an application back end 1140, a third party service 1160, and a user interface 1180. Client data systems 120 may include client manual files 1122, client file storages 1124, third party data storage services 1126, SQL databases 1128, and/or non-SQL databases 1130.

The application backend 1140 may include data analysis engine 1142 and data configuration 1144, which as will be discussed below may be received from the client data system 1120 or may be automatically generated by the application backend 1140. The data analysis engine 1142 may receive the data from the client data sources 1120 in the form of one or more data sets, each data set having its own corresponding configuration in the data configuration module 1144. Using the data configurations in the configuration module 1144 and the received data sets, the data analysis engine 1142 may generate a series of data structures known as “observed facts” 1146. The generated observed facts 1146 regarding the input data sets may be transmitted to the narratives generation engine 1148. The narratives generation engine 1148 may combine the observed facts (or a subset thereof) with language template database 1150 to generate natural language narratives 1152. Before processing by the AI chatbot, the application backend 1140 may augment the natural language narratives 1152 with a selected call to action 1154 that is selected based on a user-input query type.

The application backend 1140 may be communicatively coupled to third party service 1160 (e.g., an AI chatbot service) and user interface 1180, whose operation is described in greater detail below. The augmented natural language narratives 1182 may be transmitted directly to the user interface 1180 for display, and may also be transmitted to the AI chatbot 1162 provided by the third party service 1160 (either automatically or in response to a received user input). The AI chatbot 1162 may then generate text recommendations 1184 for display on the user interface 1180, where the text recommendations 1184 are responsive to the format and content of the augmented natural language narratives 1182.

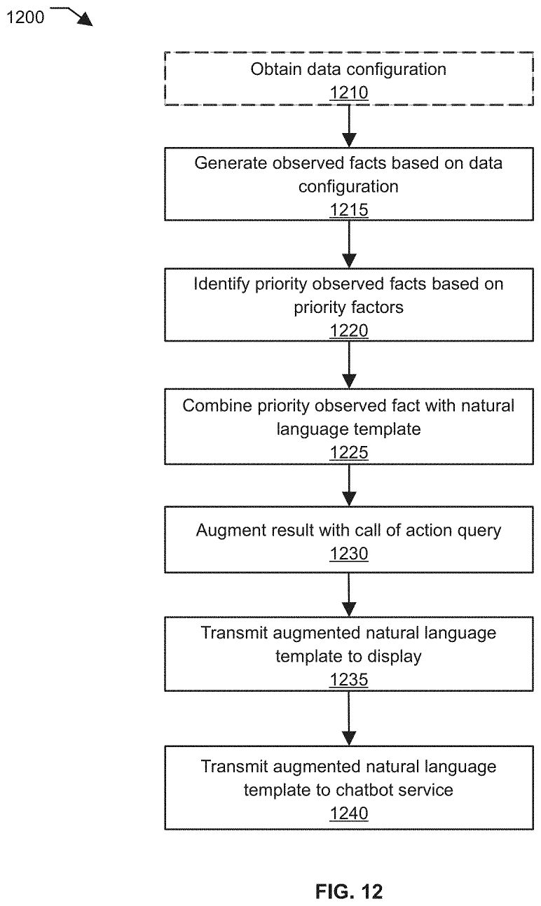

FIG. 12 is a flow diagram illustrating an example method 1200 of generating and displaying an insight graphic interface according to one or more embodiments of the disclosure. Process 1200 may use processing logic, which may include software, hardware, or a combination thereof. For example, process 1200 may be performed by a system including one or more components described in operating environment 1100. In optional block 1210, a server (e.g. application backend 1140) may obtain a data configuration 1144 of a data set received from a client device over a network connection. In order to correctly extract observed facts from the data source, the application backend system 1140 needs to have certain information about the data source structure and its constituent parts. Observed facts may be data structures stored by the application backend 1140 that track a state of a certain business metric during a certain period of time, or comparison of the states of metric in two different periods of time. The observed fact may also include additional context, referred to herein as dimensions, in the form of additional text data. The data configuration of the data set may accordingly be metadata labeling data columns of the data set, the types of data being one of a date column, a numeric column, and a context column. Date columns may indicate the beginning and end of the period for which the data in other columns was collected. Numeric columns may include values indicating various business metrics, and context columns may indicate various dimensions for which the data in the numeric columns was collected. An exemplary data set may include the following columns:
Date columns: start_date, end_date;
Numeric columns: budget_spent, impressions, clicks, conversions;
Context columns: gender, age, country, device.

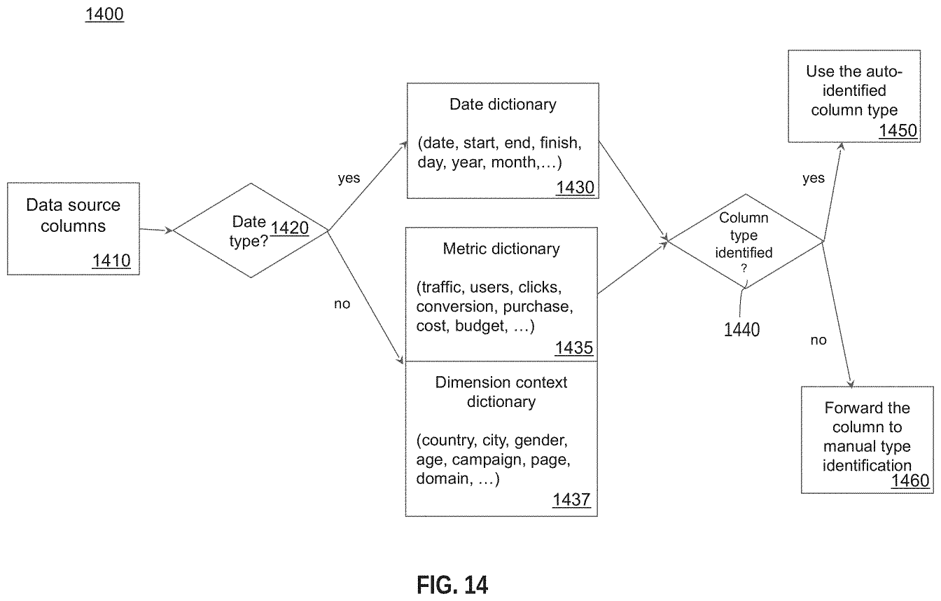

The data configuration may be obtained in several different ways. In some embodiments, the data configuration is simply received by the application backend server 1140 from the client data system 1120. The final configuration may be elaborated by a data expert upon receipt of the data set in other embodiments. Furthermore, in some embodiments the process of the dataset configuration can be automated or semi-automated using the types of data columns (date, numeric or string) and/or a previously created data set configurations since the column names can be repeated in the newly integrated data sources. FIG. 14 is a flow diagram illustrating an example method 1400 of automatically generating a data configuration for a received data set, according to one or more embodiments of the disclosure. The data configuration of the data set may be automatically determined by parsing each received column 1410 of the data set. As part of the parsing, at step 1420 the types of data in each column of the data set may be identified as being one of a date, a numeric string, and a text string. If the column includes date-type data, the date dictionary 1430 is used to identify the granularity of the date data.

If the column includes numeric data, then metric dictionary 1435 is used to match the data type to one of a set of predetermined data type labels, examples of which are shown in method 1400 (e.g., traffic, users, etc.). If the column includes context data, then dimension context dictionary 1437 is used to attempt to match the data type to one of the set of known dimension contexts, examples of which are shown in method 1400 (e.g., country, city, gender, etc.). If the data type of the column being examined matches a known data type in one of dictionaries 1430, 1435, and 1437 at step 1440, then the auto-identified column type is stored as a metadata label for the column before proceeding to the next column at step 1450. If the data type of the column does not match any known data type, then at step 1460 the data analysis engine 1142 of the application backend 1140 may forward the column to an administrator for manual creation of the metadata label for the column.

Returning to method 1200, the data analysis engine 1142 may generate observed facts from numeric-type data columns of the data set at block 1215 based on the data configuration 1144. Each observed fact may be a data structure that includes an amount of change of a corresponding numeric-type data column over a predetermined period of time. Once the meaning of the data set columns is known, the changes and fluctuations in the data metrics may be observed over time, and stored as observed facts: In some embodiments, an observed fact is a structured object which may include the following fields:
(1) start time (based on corresponding date column data);
(2) end time;
(3) metric (i.e. the numeric data label for the observed fact);
(4) metric value for the start time;
(5) metric value for the end time;
(6) type of change (increase or decrease);
(7) percent of change;
(8) dimension (when appropriate); and
(9) dimension value.

The length of the period for the observed facts can vary from one millisecond to one year (or even longer), depending on the nature of the observed data. If the length of period in the fact object is different from the data granularity of the data set, an aggregation function may need to be applied to the data (usually average or sum). Examples of Observed facts are:
Generic fact (empty dimension
Metric: number of users
Start period: Feb. 19, 2023
End period: Feb. 20, 2023
Start period value: 69
End period value: 107
Type of change: increase
Percent of change: 55%
Fact with a dimension (country)
Metric: number of page views
Dimension: country
Dimension value: Germany
Start period: Feb. 19, 2023
End period: Feb. 20, 2023
Start period value: 14000
End period value: 7000
Type of change: decrease
Percent of change: 50%

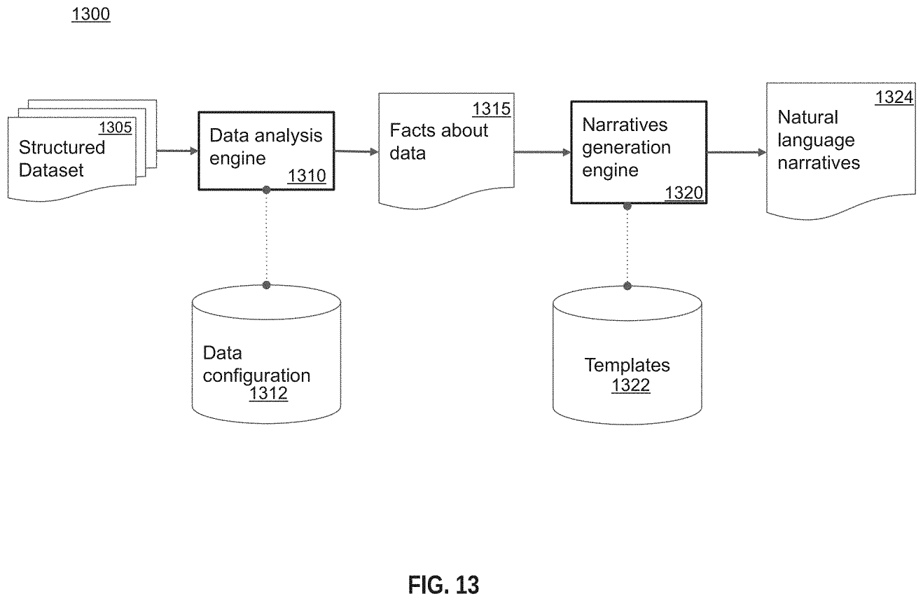

FIG. 13 is a flow diagram illustrating a data flow 1300 for generating natural language narratives from a received data set and data configuration for the data set, according to one or more embodiments of the disclosure. Data flow 1300 shows how, based on the received column-based structured dataset 1305 and data configuration retrieved from data configuration database 1312 (corresponding to data configurations 1144 in FIG. 11), the data analysis engine 1310 generates the observed facts 1315, such as the example observed facts shown above, about the dataset 1305.

From the generated observed facts, a subset of priority observed facts may be identified based on a plurality of priority factors associated with each observed fact at block 1220 of method 1200. Each priority factor may be a value assigned to the observed fact, and may be derived from data within the observed fact, or may be separately assigned, for example, based upon the column of the data set associated with the observed fact. This is based on the principle that not all the facts about the changes in metrics are significant enough to be taken into account in the decision making process. The following priority factors can be taken into account when measuring priority of an observed fact:
(1) Percent of change: where larger changes are assigned a higher priority than observed facts having smaller changes (the percent of change, as shown above, is a field in the observed facts in some embodiments);
(2) Value range coefficient: with larger absolute numbers, the importance of facts becomes more sensitive to the percent of change (e.g. on a website with 1M visitors, a 10% daily increase [which would mean +100K users] will be considered an important event, while jump from 100 to 200 users is a lot more likely and therefore less important [even though formally its a significant 100% increase]; this may be accounted for by, for example, setting a value range coefficient to 0.2 for the value range of 0-1000, 0.3 for the range of 1000-10,000, etc.);
(3) Metric importance coefficient: some metrics are more sensitive to change than others, and may be pre-assigned an importance coefficient increasing the likelihood of being selected as a priority observed fact;
(4) Dimension importance coefficient: certain dimension labels, like country or age, can be weighted as having a higher priority than other dimension labels associated with the observed facts;
(5) Dimension value importance coefficient: certain dimension values can be configured to be more important, (e.g., the United States and Germany can be configured to be most important countries when associated with observed facts).

In some embodiments, all coefficient values used to determine fact priority may be numbers in the range from 0 to 1.

Also, in some embodiments, the overall observed fact priority may be captured by a fact significance score associated with each observed fact. This may be calculated, for example; by multiplying the change value with all the coefficients:

Overall fact significance=Overall Change value*Value range coefficient*Metric importance coefficient*Dimension importance coefficient*Dimension value importance coefficient

In other embodiments, fewer or more coefficients may be used to determine the fact significance scores for each observed facts. The priority observed facts may be selected based on the fact significance scores, where a predetermined N number of facts are selected, or may be selected based on having greater than a predetermined threshold priority value, in various embodiments. The N number can be configured empirically depending on the size of data source and/or user preferences. The most important group can be displayed in the feed with the highest priority, other groups can be displayed upon clicking a “view more” button, or scrolling down the page.

To generate a natural language narrative 1324 for the AI chatbot, the server may combine one of the priority observed facts with a natural language template retrieved from a template database at block 1225 of method 1200. Referring to data flow 1300, the set of priority observed facts may be provided to the narratives generation engine 1320, which may convert a priority observed fact into a natural language narrative 1324 using templates from template database 1322. The natural language template may be a textual statement with placeholder strings, where one or more of the placeholder strings is replaced with values from the one of the priority observed facts to generate a populated natural language template. An example template may be defined as:

On {start date}, {metric} {change_type} by {change_percent}% ({start_date_value}) compared to {end_date} ({end_date_value}).

100721 Narratives generation engine 1320 may automatically apply the template to the below sample fact object to result in the following populated natural language template.

### Sample Fact:

Metric: number of users
Start period: Feb. 19, 2023
End period: Feb. 20, 2023
Start period value: 69
End period value: 107
Type of change: increase
Percent of change: 55%

### Resulting Text:

On Feb. 19, 2023, the number of users increased by 55% (107) compared to Feb. 20, 2023 (69).

Another example of populating a template with data from a priority observed fact is provided below for facts with a non-empty dimension value:

In {dimension_value}, on {start_date}, {metric} {change_type} by {change_percent}% ({start_date_value}) compared to {end_date} ({end_date_value}).

### Sample Fact:

Metric: number of page views
Dimension: country
Dimension value: Germany
Start period: Feb. 19, 2023
End period: Feb. 20, 2023
Start period value: 14000
End period value: 7000
Type of change: decrease
Percent of change: 50%

In Germany on Feb. 19, 2023, the number of page views decreased by 50% (14000) compared to Feb. 20, 2023 (7000).

This populated natural language template may then be augmented with a selected call to action query at block 1230. The call to action query may be selected based on a received user explanation type, to improve interactivity with the chatbot. For example, when the received user explanation type is a recommendation, the call to action query may be selected to be an a request for steps to perform. When the received user explanation type is an explanation, the call to action query may be selected to be a request for reasons. When the received user explanation type is an assessment, the call to action query may be selected to be a received custom user input query. Examples of each type of user explanation received, and corresponding selected call to action queries are shown below, in Table 2.

Once the fact has been translated to a natural language narrative 1152, it can be sent to an AI chatbot right away in some embodiments, since the chat interface matches the narrative format. However, in some embodiments, a call to action query 1154 may be added to the natural language narrative 1152 by the application backend 1140, in order to help the AI chatbot 1162 to understand the task and therefore provide a more precise and comprehensive output. Call to action queries may typically relate either to root causes of the fact call for explanation), or steps that can be taken in order to properly react to the situation described by the fact (call for recommendation).

Call to action queries may be formulated by data experts or may be automatically generated based on the requested user explanation type, and can be empirically tuned for specific AI chatbots for best results. Users may also be given a capability to edit the call to action queries themselves via graphic user interface 1182 after the natural language narrative 1152 is generated, so that the requests sent to the AI chatbot are fine-tuned according to their specific needs. In the below table, various calls to action are added to the example basic narratives. Two calls to are included in the default system configuration, and the third one (assessment) is a custom one, added by the user.

TABLE 2
List of exemplary Call to Action Queries selected based on received User explanation type

| Call to action type | Generated request | AI chatbot response |
|---|---|---|
| Recommendation | On Jan. 3, 2023 the number | Congratulations on the significant |
| | of new users increased by 100% | increase in your website's conversion |
| | (200) compared to Jan. 1, 2023 | rate! Here are some steps you could take |
| | (100). What could be the steps? | to further improve this positive trend: 1) |
| | | Analyze the data: Take a deeper look at |
| | | the data from Google Analytics and try to |
| | | identify any patterns or trends . . . |
| | On Jan. 3, 2023 the number | Some possible steps that you could take |
| | of new users decreased by 50% | to address a decrease in users on your |
| | (100) compared to Jan. 1, 2023 | website include: 1) Reviewing and |
| | (200). What could be the steps? | optimizing the content and design of your |
| | | site to ensure that it is relevant, valuable, |
| | | and easy to use for your target |
| | | audience . . . |
| Explanation | On Jan. 3, 2023 the number | There are a few potential reasons that the |
| | of new users increased by 100% | number of new users on a website might |
| | (200) compared to Jan. 1, 2023 | increase significantly over a short period |
| | (100). What could be the | of time. Here are a few possibilities: 1) |
| | reasons? | The website may have implemented a |
| | | new marketing campaign or promotion |
| | | that has attracted more visitors . . . |
| | On Jan. 3, 2023 the number | To gain a better understanding of the |
| | of new users decreased by 50% | factors that may have contributed to the |
| | (100) compared to Jan. 1, 2023 | decrease in users, it would be useful to |
| | (200). What could be the | gather and analyze additional data and |
| | reasons? | information, such as the performance of |
| | | other marketing campaigns or channels, |
| | | the demographics and interests of the |
| | | users who are visiting the site, and any |
| | | changes that were made . . . |
| Assessment | On Jan. 3, 2023 the number | An increase in the number of users on |
| (added by the | of new users increased by 100% | your website as indicated by Google |
| user) | (200) compared to Jan. 1, 2023 | Analytics could be a positive |
| | (100). Is it good for our | development. However, it is important to |
| | business? | carefully analyze the data and consider |
| | | the context in which the decrease |
| | | occurred to ensure that it is a meaningful |
| | | and sustainable trend . . . |
| | On Jan. 3, 2023 the number | A decrease in the number of users on your |
| | of new users decreased by 50% | website as indicated by Google Analytics |
| | (100) compared to Jan. 1, 2023 | could be a cause for concern, as it |
| | (200). What could be the | suggests that fewer people are visiting |
| | reasons? | your site and engaging with your |
| | | content . . . |

The augmented natural language template may then be transmitted to a display device at block 1235, and also to the web-based chatbot service at block 1240. The interaction between the application backend 1140 and the AI chatbot 1162 can be performed via any network interface including HTTP, HTTPS or any other, including clipboard copy-paste interface. The request can be also sent to several Al chatbots consecutively or in parallel. The chatbot service may then cause a text recommendation 1184 to be transmitted to a user device, the text recommendation providing information responsive to the format and values contained within the augmented natural language template.

The responses from the: AI chatbot(s) are received in plain text form and can be displayed to the user in real time or stored in a database in order to be displayed on demand. AI chatbot responses can be also stored in a local cache database, so that later on should the system generate similar facts there would be no need to use the network interface as the response can be retrieved directly from the cache. An example of communication bet the narrative generator and the AI chatbot may be as follows:

### Request:

In Germany on Feb. 19, 2023, the number of page views deer eased bit 50% (14000) compared to Feb. 20, 2023 (7000). What steps can he taken?

### Response:

Assuming you mean that the number of page views on Feb. 19, 2023 was 50% less than the number of page views on Feb. 20, 2023 (not the other way around), here are some steps that could be taken:
1. Investigate the cause of the drop in page views: The first step would be to find out what caused the drop in page views. Was it due to a technical issue, a change in the website content, or external factors such as a holiday or major news event? This can help identify the root cause and take appropriate action.
2. Analyze user behavior: The next step would be to analyze user behavior on the website. Are users spending less time on the website, or are they not visiting certain pages? Are there any patterns or trends in user behavior that could help identify the cause of the drop in page views?
3. Improve website content and user experience: If the drop in page views is due to issues with the website's content or user experience, steps can be taken to improve it. This could include updating content, making the website more user-friendly or improving site speed.
4. Increase marketing efforts: If the drop in page views is due to external factors, such as a decrease in demand or increased competition, the website may need to increase its marketing efforts to reach new audiences and drive traffic to the site.
5. Monitor and track performance: After taking action, its important to monitor and track the website's performance to see if there are any improvements. This can help identify, whether the steps taken were effective, or whether further, action is needed.

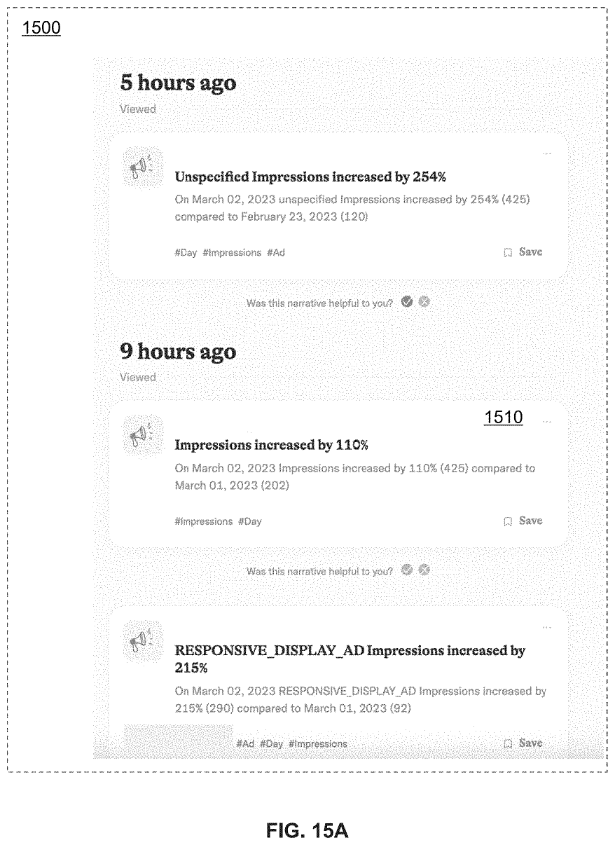

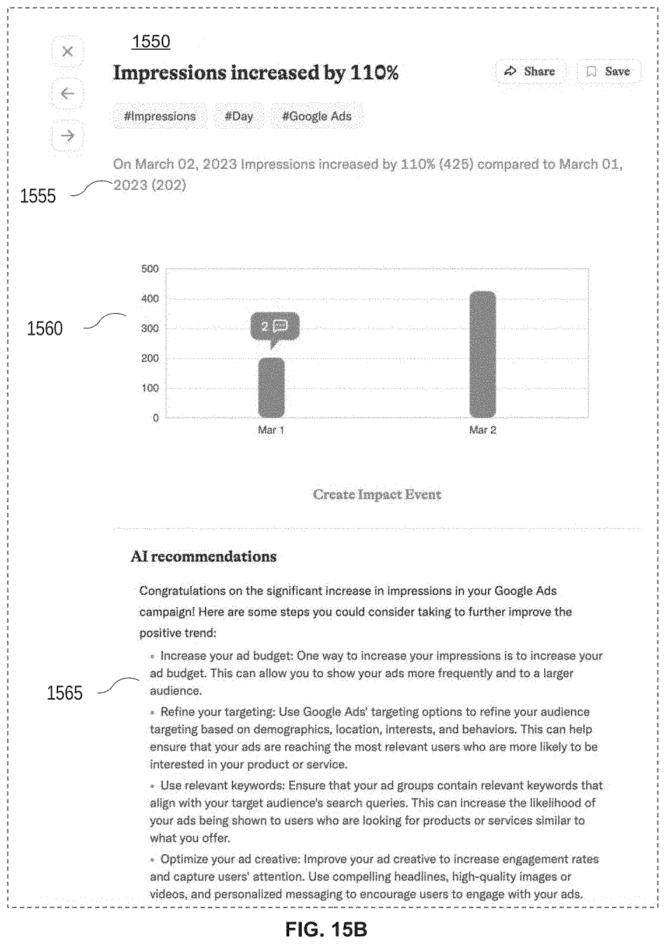

FIGS. 15A-B show exemplary interfaces 1500 and 1550 showing natural language augmented natural language templates 1510 and a corresponding text recommendation 1565 generated by an AI chatbot service, respectively, according to one or more embodiments of the disclosure. Depending on the system implementation, the call to action queries can either be displayed to or hidden from the user, as they are in interface 1500. Call to action queries may be advantageously hidden as shown to prevent distracting the user by the low level details of inter-system communication and keeping the focus on facts and insights/recommendations. Interface 1550 may be displayed to the user in response to selection of the populated natural language template 1510 in some embodiments. As shown, text recommendation 1565, the output of the AI chatbot, may be accompanied by the populated natural language template 1555 and visualization 1560 of the change in metric value of the underlying observed fact over the corresponding time period.

In the description above and throughout, numerous specific details are set forth in order to provide a thorough understanding of the disclosure. It will be evident, however, to one of ordinary skill in the art, that the disclosure may be practiced without these specific details. In other instances, well-known structures and devices are shown in block diagram form to facilitate explanation. The description of the preferred an embodiment is not intended to limit the scope of the claims appended hereto. Further, in the methods disclosed herein, various steps are disclosed illustrating some of the functions of the disclosure. One will appreciate that these steps are merely exemplary and are not meant to be limiting in any way. Other steps and functions may be contemplated without departing from this disclosure.

What is claimed is:

1. A method comprising:
generating, by a server, observed facts from numeric-type data columns of a data set received from a client device over a network connection, each observed fact being a data structure that includes an amount of change of a corresponding numeric-type data column over a predetermined period of time;
identifying, by the server, a subset of priority observed facts from the generated observed facts, the priority observed facts being identified based on a plurality of priority factors associated with each observed fact, each priority factor being a value assigned to the observed fact;
combining, by the server, one of the priority observed facts with a natural language template retrieved from a template database, the natural language template comprising a textual statement with placeholder strings, the combining comprising replacing one or more of the placeholder strings with values from the one of the priority observed facts to generate a populated natural language template;
augmenting, by the server, the populated natural language template with a selected call to action query, the call to action query being selected based on a received user explanation type;
transmitting, by the server via the network connection, the augmented natural language template to a display device; and
transmitting, by the server via the network connection, the augmented natural language template to chatbot service, the chatbot service causing a text recommendation to be transmitted to a user device, the text recommendation providing information responsive to the format and values contained within the augmented natural language template.

2. The method of claim 1, the identifying the priority observed facts being further based on a fact significance score determined for each observed fact, the fact significance score being based on at least two of the following priority factors: an overall change value for the corresponding numeric-type data column, a metric importance coefficient, and a dimension importance coefficient.

3. The method of claim 1, where the received user explanation type is one of a recommendation, where the call to action query is selected to be an a request for steps to perform, an explanation, where the call to action query is selected to be a request for reasons, and an assessment, where the call to action query is selected to be a received custom user input query.

4. The method of claim 1, further comprising storing the text recommendation in a server cache database.

5. The method of claim 4, further comprising retrieving the text recommendation from the server cache database in response to subsequently identifying an observed fact having an amount of change of a corresponding numeric-type data column over a predetermined period of time that is determined to be substantially similar to the one of the priority observed facts.

6. The method of claim 1, further comprising automatically determining a data configuration of the data set by parsing each column of the data set, identifying the types of data in each column of the data set as being one of a date, a numeric string, and a text string, and storing a label for each column with the identified data type in the column before proceeding to the next column.

7. The method of claim 1, further comprising receiving, by the server, a data configuration of the data set, the data configuration comprising metadata labeling data columns of the data set, the types of data being one of a date column, a numeric column, and a context column.

8. A system comprising:
one or more processors; and
a non-transitory computer-readable medium storing a plurality of instructions, which when executed, cause the one or more processors to:
generate observed facts from numeric-type data columns of the data set received from a client device over a network connection, each Observed fact being a data structure that includes an amount of change of a corresponding numeric-type data column over a predetermined period of time;
identify a subset of priority observed facts from the generated observed facts, the priority observed facts being identified based on a plurality of priority factors associated with each observed fact; each priority factor being a value assigned to the observed fact;
combine one of the priority observed facts with a natural language template retrieved from a template database, the natural language template comprising a textual statement with placeholder strings, the combining comprising replacing one or more of the placeholder strings with values from the one of the priority observed facts to generate a populated natural language template;
augment the populated natural language template with a selected call to action query, the call to action query being selected based on a received user explanation type;
transmit, via the network connection, the augmented natural language template to a display device; and
transmit, via the network connection, the augmented natural language template to chatbot service, the chatbot service causing a text recommendation to be transmitted to a user device, the text recommendation providing information responsive to the format and values contained within the augmented natural language template.

9. The system of claim 8, the identifying the priority observed facts being further based on a fact significance score determined for each observed fact, the fact significance score being based on at least two of the following priority factors: an overall change value for the corresponding numeric-type data column, a metric importance coefficient, and a dimension importance coefficient.

10. The system of claim 8, where the received user explanation type is one of a recommendation, where the call to action query is selected to be a request for steps to perform, an explanation, where the call to action query is selected to be a request for reasons, and an assessment, where the call to action query is selected to be a received user input query.

11. The system of claim 8, the instructions further causing the one or more processors to store the text recommendation in a server cache database.

12. The system of claim 11, the instructions further causing the one or more processors to retrieve the text recommendation from the server cache database in response to subsequently identifying an observed fact having an amount of change of a corresponding numeric-type data column over a predetermined period of time that is determined to be substantially similar to the one of the priority observed facts.

13. The system of claim 8, the instructions further causing the one or more processors to automatically determine a data configuration of the data set by parsing each column of the data set, identifying the types of data in each column of the data set as being one of a date, a numeric string, and a text string, and storing a label for each column with the identified data type in the column before proceeding to the next column.

14. A non-transitory computer readable storage medium having embodied thereon a program, the program being executable by a processor for performing a method comprising:
generating observed facts from numeric-type data columns of the data set received from a client device over a network connection, each observed fact being a data structure that includes an amount of change of a corresponding numeric-type data column over a predetermined period of time;
identifying a subset of priority observed facts from the generated observed facts, the priority observed facts being identified based on a plurality of priority factors associated with each observed fact, each priority factor being a value assigned to the observed fact;
combining one of the priority observed facts with a natural language template retrieved from a template database, the natural language template comprising a textual statement with placeholder strings, the combining comprising replacing one or more of the placeholder strings with values from the one of the priority observed facts to generate a populated natural language template;
augmenting the populated natural language template with a selected call to action query, the call to action query being selected based on a received user explanation type;
transmitting the augmented natural language template to a display device; and
transmitting the augmented natural language template to chatbot service, the chatbot service causing a text recommendation to be transmitted to a user device, the text recommendation providing information responsive to the format and values contained within the augmented natural language template.

15. The non-transitory computer readable storage medium of claim 14, the identifying the priority observed facts being further based on a fact significance score determined for each observed fact, the fact significance score being based on at least two of the following priority factors: an overall change value for the corresponding numeric-type data column, a metric importance coefficient, and a dimension importance coefficient.

16. The non-transitory computer readable storage medium of claim 14, where the received user explanation type is one of a recommendation, where the call to action query is selected to be an a request for steps to perform, an explanation, where the call to action query is selected to be a request for reasons, and an assessment, where the call to action query is selected to be a received user input query.

17. The non-transitory computer readable storage medium of claim 14, the method further comprising storing the text recommendation in a server cache database.

18. The non-transitory computer readable storage medium of claim 17, the method further comprising retrieving the text recommendation from the server cache database in response to subsequently identifying an observed fact having an amount of change of a corresponding numeric-type data column over a predetermined period of time that is determined to be substantially similar to the one of the priority observed facts.

19. The non-transitory computer readable storage medium of claim 14, the method further comprising automatically determining a data configuration of the data set by parsing each column of the data set, identifying the types of data in each column of the data set as being one of a date, a numeric string, and a text string, and storing a label for each column with the identified data type in the column before proceeding to the next column.

20. The non-transitory computer readable storage medium of claim 14, the method further comprising receiving a data configuration of the data set, the data configuration comprising metadata labeling data columns of the data set, the types of data being one of a date column, a numeric column, and a context column.
